(19) United States
(12) Patent Application Publication
(10) Pub. No.: US 2019/0202743 A1
(43) Pub. Date: Jul. 4, 2019

(54) SILICON CARBIDE-NATURED REFRACTORY BLOCK

(71) Applicant: TYK Corporation, Minato-ku (JP)

(72) Inventor: Kenji Yanagi, Tajimi-shi (JP)

(73) Assignee: TYK Corporation, Minato-ku (JP)

(21) Appl. No.: 16/232,851

(22) Filed: Dec. 26, 2018

Related U.S. Application Data
(62) Division of application No. 15/059,487, filed on Mar. 3, 2016, now abandoned.

(30) Foreign Application Priority Data
Mar. 4, 2015 (JP) 2015-042455

(51) Int. Cl. C04B 35/565; C04B 41/00; C04B 41/50; C04B 41/87

(52) U.S. Cl. CPC C04B 35/565; C04B 41/009; C04B 2237/54; C04B 41/87; C04B 41/5035

(57) ABSTRACT

A silicon carbide-natured refractory block includes a fire-resistant block body, and a calcination coated layer.

The fire-resistant block body includes a silicon carbide-natured refractory having a predetermined configuration. The calcination coated layer includes silicon oxide made by heating an outer superficial portion of the fire-resistant block body to oxidize at least some of silicon carbide therein to turn the silicon carbide into the silicon oxide. The silicon oxide sinters the calcination coated layer to increase the corrosion resistance.

### INCORPORATION BY REFERENCE

The present invention is based on Japanese Patent Application No. 2015-042455, filed on Mar. 4, 2015, the entire contents of which are incorporated herein by reference.

### BACKGROUND OF THE INVENTION

### Field of the Invention

The present invention relates to a silicon carbide-natured refractory block.

### Description of the Related Art

Conventionally, silicon carbide-natured refractory blocks have been heretofore used widely for various industries, especially, as core materials for such industries as blast-furnace industries. Since the refractory blocks are molded as predetermined configurations in advance, they have such advantages as being portable as component parts, and being capable of making larger structures by laminating the blocks with each other. The silicon carbide-natured refractory blocks have been improved variously in terms of the durability from such standpoints as the corrosion resistance (or erosion resistance), the spall resistance (or thermal-shock resistance) and the slaking resistance. For example, Japanese Unexamined Patent Publication (KOKAI) Gazette No.2010-275120 discloses to provide a castable refractory with spall resistance by using pulverized granules, which are made by pulverizing a silicon nitride-bonded SiC refractory with an oxidation-resistant film formed thereon by calcination, as an SiC raw material.

### SUMMARY OF THE INVENTION

A refractory block has been sought for, the refractory block provided with much better performance, such as being more usable industrially or exhibiting higher durability, for instance.

The present inventor noticed that heating a silicon carbide-natured refractory block in an oxidizing atmosphere results in a layer in the superficial portion, layer which leads to providing the refractory block with increased corrosion resistance, and thus arrived at inventing the present invention.

For example, a silicon carbide-natured refractory block according to the present invention comprises:

a fire-resistant block body including a silicon carbide-natured refractory having a predetermined configuration; and

a calcination coated layer including silicon oxide made by heating an outer superficial portion of the fire-resistant block body to oxidize at least some of silicon carbide therein to turn the silicon carbide into the silicon oxide.

The present silicon carbide-natured refractory block comprises the fire-resistant block body, and the calcination coated layer. The present silicon carbide-natured refractory block has a predetermined configuration depending on its objects. For example, the present silicon carbide-natured refractory block, which is molded by a mold form, comes to have a predetermined configuration according to the mold form. In addition to this, the present silicon carbide-natured refractory block, which is formed by cutting at predetermined intervals a long-length object having a constant cross section, comes to have a predetermined configuration. The fire-resistant block body includes a silicon carbide-natured refractory. Note herein that the term, “silicon carbide-natured,” means including silicon carbide in a broad sense. Since silicon carbide is oxidized to sinter the calcination coated layer, it is difficult to form the calcination coated layer when silicon carbide is included less in the fire-resistant block body before the calcination. Therefore, a preferable silicon carbide-natured refractory of the fire-resistant block body can include silicon carbide as a silicon carbide-natured substance in an amount of 5% by mass or more when all the components of the fire-resistant block body are taken as 100% by mass (hereinafter, “%” signifies “% by mass” unless otherwise specified). Moreover, a more preferable silicon carbide-natured refractory can include silicon carbide in an amount of 50% by mass or more when the entire fire-resistant block body is taken as 100% by mass.

The components of the fire-resistant block body other than silicon carbide, the following can be given: oxides of silicon, aluminum and calcium; and carbides of aluminum and calcium. Moreover, the fire-resistant block body can also include a metal, such as metallic silicon. The components other than silicon carbide, and their blending proportions can be employed separately depending on applications of the present silicon carbide-natured refractory block. Note that the respective components can be granules, or can have a granular shape, respectively. The grain sizes and grain-size distributions can be selected appropriately depending on the applications.

A type of the fire-resistant block body can be selected from any one of the following: a castable block with a predetermined configuration cast by pouring a castable into a mold, a press-molded block formed as a predetermined configuration by press molding a moldable within a mold, and a calcination block made by calcining a molded body with a predetermined configuration. Note herein that the “castable block” is a block which has been also referred to as a pre-cast block, and which is made by turning a granular or granule-shaped refractory into a slurry-like substance with water and then pouring the slurry-like substance into a mold to solidify it to a predetermined configuration. The “press-molded block” is a block in which a powdery, granular or granule-shaped refractory is consolidated by pressing it within a mold. Since the press-molded block is usually put in a more packed state than the castable block, it exhibits lower porosity. The “calcination block” is a sintered block which is made by heating a molded block, such as the castable block or the press-molded block.

Since silicon carbide reacts with oxygen to turn into silicon oxide, a silicon carbide-natured refractory is usually sintered in a non-oxidizing atmosphere. Moreover, a calcination additive agent, such as metallic silicon or metallic oxide, has been employed occasionally in order to facilitate the sintering.

The calcination coated layer of the present silicon carbide-natured refractory block is a coated layer that is made by calcining in the presence of oxygen a superficial portion of the fire-resistant block body, which includes the silicon carbide-natured refractory having a predetermined configuration; in which the components of silicon carbide contained in the superficial portion is oxidized to turn into silicon oxide; and in which sintering of the superficial portion has been promoted.

It is preferable to set a thickness of the calcination coated layer at 0.5 mm or more.

When the calcination coated layer is formed on the fire-resistant block body, the lower the original or pre-calcination heat-resistant block body exhibits mechanical strength, the higher the formation of the calcination coated layer effects the advantage of upgrading corrosion resistance. Therefore, it is more effective to form the calcination coated layer on a castable block having high porosity than on a press-molded block having low porosity. However, the advantage of upgrading corrosion resistance arises even when forming the calcination coated layer on the press-molded block. Moreover, it is also effective to further calcine under an oxygen environment a calcination block, which has been made by calcining under a non-oxygen environment a castable block or press-molded block, to form the calcination coated layer.

The silicon carbide-natured refractory block according to the present invention exhibits better affinity to a castable than a silicon carbide-natured refractory block free of the calcination coated layer but having an identical composition when joining the blocks with each other by the castable, and moreover shows increased corrosion resistance. In addition, the present silicon carbide-natured refractory block has high corrosion resistance to blast-furnace slag, and high spall resistance thereto. Consequently, the present silicon carbide-natured refractory block exhibits high durability to serve as a refractory block for blast-furnace molten steels.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is an enlarged cross-sectional diagram for illustrating partially a calcination castable refractory block according to Example of the present invention.

FIG. 2 is a silicon-element analysis diagram for showing a distribution of silicon in a cross-sectional part of the calcination castable refractory block according to Example of the present invention.

FIG. 3 is an oxygen-element analysis diagram for showing a distribution of oxygen in the same cross-sectional part as illustrated in FIG. 2.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

### EXAMPLE

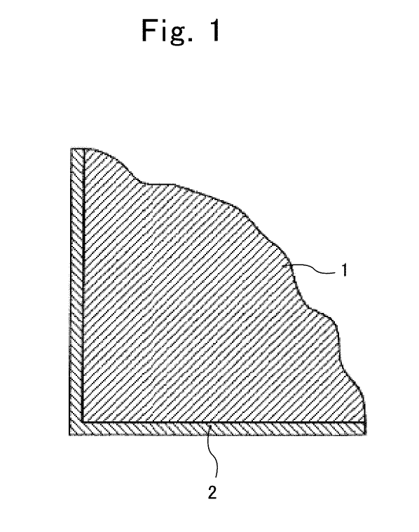

A preferable embodiment of the present invention will be hereinafter described. FIG. 1 illustrates a calcination castable refractory block according to Example of the present invention partially in an enlarged cross-sectional diagram. The calcination castable refractory block has a configuration with a size of 500 mm×500 mm×300 mm, and comprises a fire-resistant block body 1, and a calcination coated layer 2. The fire-resistant block body 1 includes a silicon carbide-natured refractory. The calcination coated layer 2 is made by heating an outer superficial portion of the fire-resistant block body 1 within an oxygen atmosphere to oxidize at least some of silicon carbide therein to turn it into silicon oxide.

The present calcination castable refractory block according to Example was obtained by the following method. First of all, a silicon carbide-natured castable, which included Al₂O₃, SiO₂ and SiC in a chemical constituent ratio of 3% by mass, 4% by mass and 86% by mass, respectively, was prepared. The silicon carbide-natured castable was used to mold a castable refractory block having 500 mm×500 mm×300 mm in size, and thereafter the silicon carbide-natured castable was dried at 110° C. for 24 hours to make the castable refractory block. Then, the castable refractory block was heated at a high temperature of 1,400° C. or more in air for a few hours to form the calcination coated layer having a thickness of 1 mm approximately on the surface. Thus, the present calcination castable refractory block according to Example was completed.

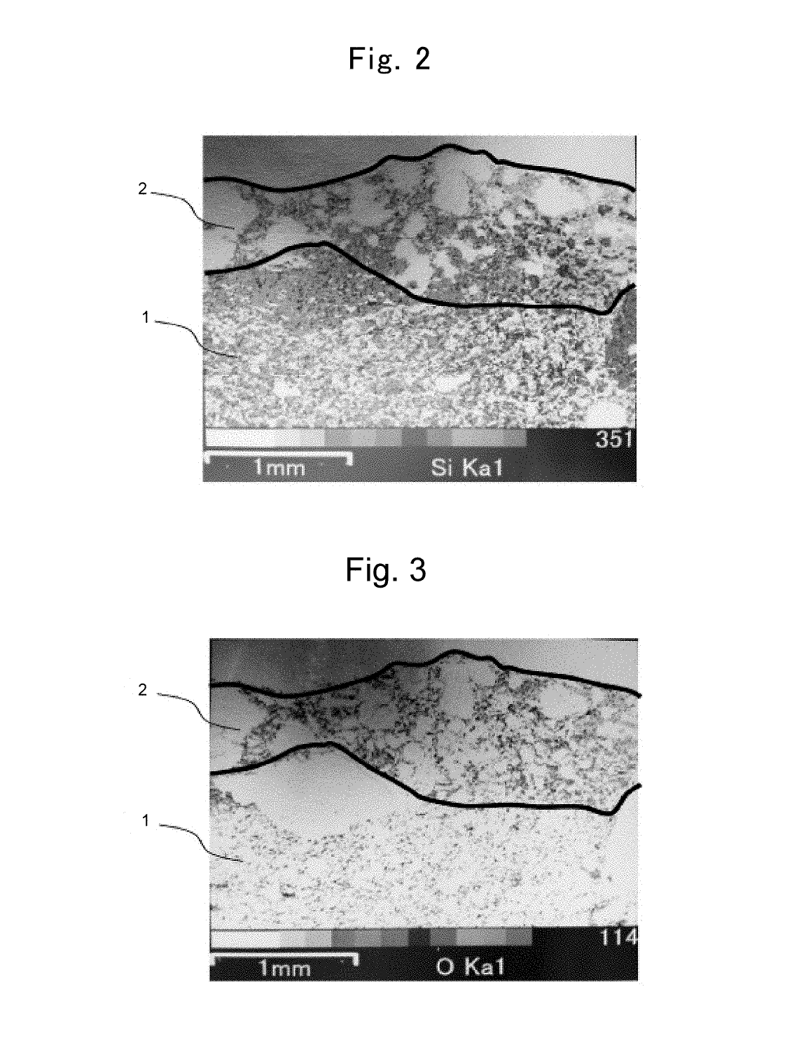

The present calcination castable refractory block according to Example was cut to examine silicon-and oxygen-element distributions in a cross-sectional part of the fire-resistant block body 1 including the calcination coated layer 2. FIG. 2 shows the silicon-element distribution in a diagram, and FIG. 3 shows the oxygen-element distribution in another diagram. Note that, in both of FIGS. 2 and 3, a bold black line is drawn on a superficial boundary of the calcination coated layer 2, and another bold black line is drawn on a boundary between the calcination coated layer 2 and the block body 1. Therefore, in FIGS. 2 and 3, the calcination coated layer 2 corresponds to a section between the two bold black lines extending in the right and left, and a part of the block body 1 corresponds to a downward section under the lower bold black line. Since a section where oxygen exists becomes black, and since the part of the calcination coated layer 2 is blacker in FIG. 3 than the part of the block body 1, it is understood from FIG. 3 that oxygen was present more in the calcination coated layer 2 than in the block body 1. Moreover, since the black section of the calcination coated layer 2 in FIG. 2 indicates that silicon abounded, it is understood that the black section of the calcination coated layer 2 was silicon oxide. In addition, white sections in FIG. 2 are construed to be voids.

The present calcination castable refractory block according to Example exhibited a porosity of 10.1%, and a bulk specific gravity of 2.63%. Moreover, the present calcination castable refractory block had a compressive strength (i.e., one of the strengths) of 81 MPa, and a bending strength of 39 MPa. The present calcination castable refractory block was subjected to a corrosion test. Using a corrosive agent including blast-furnace slag (whose basicity “C/S” was 1.0) to which mill scale was added in an amount of 10%, the corrosion test was carried out by an induction-furnace dipping method under the following conditions: a testing temperature at from 1,500 to 1,550° C.; and a corrosion time for 6 hours. According to the corrosion test, the present calcination castable refractory block exhibited a corrosion depth of 1.7 mm at the slag-line “SL” section. Moreover, the present calcination castable refractory block was further subjected to a spall resistance test which was carried out by an induction-furnace dipping method under the following conditions: a testing temperature at from 1,450 to 1,550° C.; a one-cycle immersion time for 15 minutes; and an air-cooling time for 15 minutes. According to the spall resistance test, the present calcination castable refractory block endured seven rounds by a number of cycles until it fractured to fall down.

For comparison, a castable refractory block on which no calcination coated layer was formed was subjected to the same tests as set forth above. The castable refractory block with no calcination coated layer formed exhibited a porosity of 14.8%, and a bulk specific gravity of 2.42%. Moreover, the castable refractory block with no calcination coated layer had a compressive strength of 12 MPa, and a bending strength of MPa. According to the corrosion test, the castable refractory block free from the calcination coated layer 2 exhibited a corrosion depth of 5.1 mm at the slag-line “SL” section. According to the spall resistance test, the castable refractory block free from the calcination coated layer 2 endured seven rounds by a number of cycles until it fractured to fall down.

As described above, the silicon carbide-natured refractory block according to the present invention, especially, the present calcination castable refractory block according to Example had a compressive strength of 81 MPa, and a bending strength of 39 MPa. On the contrary, the ordinary castable refractory block had a compressive strength of 12 MPa, and a bending strength of 3 MPa. Comparing the strengths, the present calcination castable refractory block exhibited the characteristics which were enhanced extremely with respect to those of the ordinary castable refractory block. Moreover, as to the corrosion resistance, the corrosion depth was decreased greatly to 1.7 mm in the present calcination castable refractory block from 5.1 mm in the ordinary castable refractory block. In addition, the present calcination castable refractory block could maintain the spall resistance.

Thus, the silicon carbide-natured refractory block according to the present invention comprising a noble layer (i.e., the calcination coated layer) in the superficial portion exhibits increased corrosion resistance to serve as a refractory block.

Having now fully described the present invention, it will be apparent to one of ordinary skill in the art that many changes and modifications can be made thereto without departing from the spirit or scope of the present invention as set forth herein including the appended claims.

1-4: (canceled)

5. A process for producing a silicon carbide-natured refractory block comprising:
a step of forming a castable block with a predetermined configuration cast by pouring a castable into a mold, the castable including silicon carbide in an amount of 50% by mass or more when the entire body is taken as 100% by mass,
a step of calcining the castable block in the presence of oxygen and oxidizing at least a part of silicon carbide to be silicon oxide.

6. The process for producing the silicon carbide-natured refractory block according to claim 5, wherein the castable block is poured into the mold to be solidified.

7. The process for producing the silicon carbide-natured refractory block according to claim 5, wherein the castable block is poured into and pressed within the mold to be consolidated.

8. The process for producing the silicon carbide-natured refractory block according to claim 5, wherein the castable block is dried and thereafter is heated in an oxygen atmosphere.
